(19) United States
(12) Patent Application Publication
(10) Pub. No.: US 2026/0237921 A1
(43) Pub. Date: Aug. 13, 2026

(54) ELECTRICAL FERRULE, ELECTRICAL CONTACT WITH FERRULE AND METHOD FOR ASSEMBLING A SYSTEM WITH AN ELECTRICAL FERRULE

(71) Applicant: TE Connectivity Solutions GmbH, Schaffhausen (CH)

(72) Inventors: Matthew Steven HOUSER, Middletown, PA (US); Robert WUERKER, Bensheim (DE); Olivier DE CLOET, Bensheim (DE)

(21) Appl. No.: 19/535,133

(22) Filed: Feb. 10, 2026

(30) Foreign Application Priority Data
Feb. 13, 2025 (EP) 25157806.8

(51) Int. Cl. H01R 11/28; H01R 4/18; H01R 4/20

(52) U.S. Cl. CPC H01R 11/28; H01R 4/183; H01R 4/20

(57) ABSTRACT

An electrical ferrule with self-locking arrangement includes a ferrule body having a first flank and a second flank extending along an axial direction of the ferrule body, wherein the self-locking arrangement comprises at least one locking projection formed on the first flank and at least one locking recess formed on the second flank, wherein the locking recess comprises an insertion opening, a deformation wall and at least one undercut, wherein the locking projection is arranged to be pushed into the locking recess via the insertion opening, to be pressed against the deformation wall and to be plastically deformed into a deformed state when an external radial pressure is applied onto the ferrule, and wherein the locking projection in the deformed state is arranged to at least partially extend into the at least one undercut of the locking recess.

### CROSS REFERENCE TO RELATED APPLICATIONS

This application claims the benefit of EP Application No. 25157806.8, filed 13 Feb. 2025, the subject matter of which is herein incorporated by reference in its entirety.

### BACKGROUND OF THE INVENTION

The subject matter herein relates to an electrical ferrule, an electrical contact with a ferrule and a method for assembling a system with a ferrule.

Electrical ferrules and electrical contact elements for electrical contacting, in particular in automotive industry, are well known from state of the art. Electrical ferrules with self-locking mechanism are also known from state of the art.

### BRIEF DESCRIPTION OF THE INVENTION

An objective of the subject matter herein is providing an improved electrical ferrule, an improved electrical contact with a ferrule and an improved method for assembling a system with an electrical ferrule.

In various embodiments, the objective is solved by the ferrule, the contact and the method of the independent claims. The dependent claims provide favorable embodiments.

According to an aspect an electrical ferrule with self-locking arrangement is provided, wherein the ferrule comprises a ferrule body comprising a first flank and a second flank extending along an axial direction of the ferrule body, wherein the self-locking arrangement comprises at least one locking projection formed on the first flank and at least one locking recess formed on the second flank, wherein the locking recess comprises an insertion opening, a deformation wall and at least one undercut, wherein the locking projection is arranged to be pushed into the locking recess via the insertion opening, to be pressed against the deformation wall and to be plastically deformed into a deformed state when an external radial pressure is applied onto the ferrule, and wherein the locking projection in the deformed state is arranged to at least partially extend into the at least one undercut of the locking recess.

This can achieve the technical advantage, that an improved electrical ferrule with self-locking arrangement can be provided. The ferrule comprises a first flank and a second flank extending along an axial direction of the ferrule body with the self-locking arrangement comprising at least one locking projection formed on the first flank and one locking recess formed on the second flank. The locking recess comprises an insertion opening, a deformation wall and at least one undercut.

The locking projection is arranged to be pushed into the locking recess via the insertion opening, being pressed against the deformation wall and being plastically deformed at least partially extending into the undercut, by an external radial pressure applied onto the electrical ferrule.

Due to these features of the locking projection the ferrule can be connected to a conductor by means of a normal crimping process in which the external radial pressure is applied to the ferrule to provide the crimp connection to the conductor.

The self-locking arrangement, in form of the deformable locking projection that can be pressed into the locking recess and be deformed such that it at least partially extends into the undercut of the locking recess automatically locks the two flanks of the ferrule body to each other. This way, the crimping connection is secured and the ferrule is connected more tightly to the cable.

As the locking projection is automatically pressed into the locking recess and deformed into a deformed state in which the locking projection at least partially extends into the undercut to provide the self-locking function of the self-locking arrangement, the locking projection does not need to be positioned in the locking recess before performing the crimping process. This simplifies the crimping process.

According to an embodiment the locking projection is arranged to be plastically deformed in a circumferential direction and/or the axial direction of the ferrule body.

This can achieve the technical advantage, that due to the plastic deformation of the locking projection in circumferential direction and/or axial direction of the ferrule body the locking projection can be deformed in optimal way in order to extend into the undercut and provide the self-locking of the ferrule.

According to an embodiment in an undeformed state the locking projection does not extend at least partially into the at least one undercut of the locking recess.

This can achieve the technical advantage, that the undeformed locking projection can easily be inserted into the locking recess via the insertion opening when the external pressure is applied onto the ferrule. In addition to this, the locking projection can be manufactured more easily as it comprises a simple shape.

According to an embodiment in the deformed state the locking projection comprises a deformed shape with a deformed outline and/or an enlarged or reduced base area.

This can achieve the technical advantage, that due to the deformation of the locking projection, which can comprise a deformed outline and/or an enlarged or reduced base area, an optimized deformation of the locking projection can be achieved that allows the locking projection to optimally extend into the undercut of the locking recess.

According to an embodiment the undercut is formed by a first side wall of the locking recess, wherein the deformation wall is formed by a second side wall of the locking recess, and wherein the second side wall is formed as a sloped wall with a slope of the second side wall being oriented in direction of the first side wall.

This can achieve the technical advantage, that due to the deformation wall being formed by a second side wall of the locking recess, which is formed as a sloped wall with a slope of the second side wall oriented in direction of the first side wall, the locking projection can easily be deformed and pushed into the recess formed in the first side wall of the locking recess, when being pushed against the deformation wall by the applied external pressure.

Due to the easy deformation of the locking projection by the external pressure pressing the locking projection against the deformation wall, the self-locking can easily be achieved during the crimping process of the ferrule.

According to an embodiment the first side wall is formed as a sloped wall with a slope of the first side wall aligned to the slope of the second side wall.

This can achieve the technical advantage, that due to the formation of the first side wall as a sloped wall with a slope aligned to the slope of the second side wall, a simple design of the locking recess including the undercut can be achieved. This allows for an easy manufacturing of the ferrule.

According to an embodiment the first side wall is formed as a straight wall comprising the undercut.

This can achieve the technical advantage, that a simple design of the locking recess comprising the undercut can be provided. This allows for a simple manufacturing process of ferrule.

According to an embodiment the locking recess comprises two undercuts formed on two sidewalls of the locking recess, and wherein the deformation wall is formed by a base wall opposite to the insertion opening.

This can achieve the technical advantage, that due to the multiple undercuts formed in the two side walls of the locking recess an improved self-locking can be achieved by the deformation of the locking projection, in which the locking projection extends into both undercuts of the locking recess.

As the deformation wall is formed by a base wall of the locking recess opposite to the insertion opening, the locking projection inserted into the locking recess and pressed against the deformation wall can be deformed such that it extends into both undercuts. This allows for an optimized deformation and an easy design of the locking recess.

According to an embodiment the self-locking arrangement further comprises at least one further locking projection formed on the second flank and at least one further locking recess formed on the first flank, wherein the further locking recess comprises an insertion opening, a deformation wall and at least one undercut, wherein the further locking projection is arranged to be pushed into the locking recess via the insertion opening, to be pressed against the deformation wall and to be plastically deformed into a deformed state when an external radial pressure is applied onto the ferrule, and wherein the further locking projection in the deformed state is arranged to at least partially extend into the at least one undercut of the locking recess.

This can achieve the technical advantage, that due to the further locking projection and further locking recess an improved self-locking of the ferrule can be achieved.

According to an embodiment the locking projection comprises a beam shape, and/or wherein the locking projection comprises at least one hook element arranged to extend into the at least one undercut.

This can achieve the technical advantage, that due to the beam shape of the locking projection an easy design of the locking projection and a respective easy manufacturing process can be provided.

With the locking projection comprising at least one hook element arranged to extend into the at least one undercut an improved self-locking can be provided, as due to the hook element the locking projection can better extend into the undercut when being deformed into the deformed state.

According to an embodiment the locking projection is formed as a frame element with a hollow inner region.

This can achieve the technical advantage, that due to the frame element with hollow inner region and easy plastic deformation can be achieved, even for small external pressures. Due to the easy to achieve plastic deformation the locking projection can be deformed in a way that it extends optimally into the undercut.

According to an embodiment the ferrule body is formed in one piece by means of a punching process and a bending process.

This can achieve the technical advantage, that the ferrule is easy to manufacture.

According to an aspect an electrical contact element with a ferrule according to any of the preceding embodiments is provided.

This can achieve the technical advantage, that an improved electrical contact element with a ferrule with the abovementioned technical advantages can be provided.

According to an aspect a system comprising a ferrule according to any of the preceding embodiments or an electrical contact element with a ferrule and a conductor is provided, wherein the ferrule is positioned on the conductor, wherein the ferrule is connected to the conductor by means of a crimp connection, wherein the locking projection of the first flank of the ferrule body protrudes into the locking recess of the first flank of the ferrule body, contacts the deformation wall, is plastically deformed to the deformed state and extends at least partially into the at least one undercut of the locking recess, and wherein the plastic deformation of the locking projection at least partially into the undercut results in an external radial pressure applied onto the ferrule during a crimping process to achieve the crimp connection.

This can achieve the technical advantage, that an improved system comprising a ferrule or an electrical contact element with a ferrule and a conductor can be provided. Due to the abovementioned technical advantages of the ferrule an improved connection of the ferrule with the conductor by means of a crimp connection can be provided.

According to an aspect a method for assembling a system is provided, comprising:
Providing a ferrule according to any of the preceding embodiments or an electrical contact element with a ferrule positioned on a conductor;
Executing a crimping process by applying external radial pressure onto the ferrule positioned on the conductor and by this pushing the locking projection into the locking recess via the insertion opening, pressing the locking projection against the deformation wall and plastically deforming the locking projection into a deformed state of the locking projection at least partially extending into the undercut of the locking recess.

This can achieve the technical advantage, that an improved method for assembling a system with a ferrule or a contact element and with a ferrule and a conductor can be provided. Due to the technical advantages of the ferrule an improved crimp connection with self-locking of the ferrule can be achieved.

### BRIEF DESCRIPTION OF THE DRAWINGS

The invention is explained below in more detail with reference to the figures. It shows:

FIG. 1 illustrates a perspective schematic view of an electrical ferrule according to an embodiment,

FIG. 2 illustrates a perspective schematic view of an electrical contact element with an electrical ferrule according to an embodiment,

FIGS. 3 and 3a illustrate a perspective schematic view of a system comprising an electrical contact element with an electrical ferrule according to an embodiment,

FIGS. 4 and 4a illustrate a perspective schematic view of a system comprising an electrical contact element with an electrical ferrule according to another embodiment,

FIGS. 5a, 5b, 5c and 5d illustrate an illustration of a method of assembling a system comprising an electrical contact element with an electrical ferrule according to an embodiment,

FIGS. 6a and 6b illustrates a schematic view of an electrical ferrule according to an embodiment,

FIGS. 7a and 7b illustrate a schematic view of an electrical ferrule according to another embodiment,

FIGS. 8a and 8b illustrate a schematic view of an electrical ferrule according to another embodiment,

FIGS. 9a and 9b illustrate a schematic view of an electrical ferrule according to another embodiment,

FIGS. 10a and 10b illustrate a schematic view of an electrical ferrule according to another embodiment, and

FIGS. 11a and 11b illustrate a schematic view of an electrical ferrule according to another embodiment.

### DETAILED DESCRIPTION OF THE INVENTION

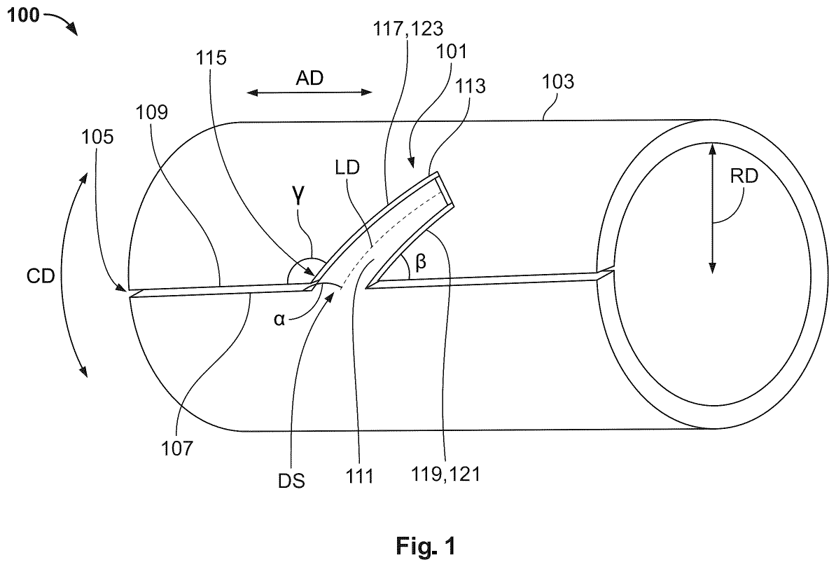

FIG. 1 shows a perspective schematic view of an electrical ferrule 100 according to an embodiment.

The ferrule 100 comprises a ferrule body 103 with a self-locking arrangement 101. The ferrule body 103 has a mostly cylindrical shape with a first flank 107 and a second flank 109 separate by a gap 105 extending along an axial direction AD of the ferrule 100.

The self-locking arrangement 101 comprises a locking projection 111 formed on the first flank 107 and a locking recess 113 formed on the second flank 109. The locking recess 113 comprises an insertion opening 115, a deformation wall 117 and an undercut 119.

The locking projection 111 is arranged to be pushed into the locking recess 113 via the insertion opening 115, to be pressed against the deformation wall 117 and to be deformed into a deformed state DS, in which the locking projection 111 at least partially extends into the undercut 119 of the locking recess 113, when an external radial pressure is applied onto the ferrule 100.

Due to the plastic deformation of the locking projection 111 positioned in the locking recess 113 and partially extending into the undercut 119, the self-locking arrangement 101 provides a locking of the ferrule 100 in the illustrated state, in which the first and second flanks 107, 109 are positioned adjacent to each other.

The locking projection 111 is arranged to be automatically pushed into the locking recess 113 and deformed into the respective deformed state DS by the external pressure and the respectively formed deformation wall 117, when the external radial pressure is applied onto the ferrule 100.

As a result, the described locking of the self-locking arrangement is generated automatically during a crimping process, in which the respective ferrule 100 is contacted to a respective conductor. Since the locking projection 111 is arranged to automatically glide into the locking recess 113, the locking projection 111 does not need to be positioned in the locking recess 113 prior to the execution of the crimping process.

Since the deformation of the locking projection 111 into the deformed state DS, in which the locking projection 111 is positioned to extend at least partially into the undercut 119 of the locking recess 113, also takes place automatically when the external radial pressure is applied on the ferrule 100, the locking projection 111 does not need to be positioned in the undercut 119 of the locking recess 113 prior to the execution of the crimping process.

Thus, the self-locking effect of the self-locking arrangement 101 is automatically achieved, when the crimping process is executed and the external radial pressure is applied onto the ferrule 100.

In the sense of the application, the external radial pressure is directed in a radial direction RD of the ferrule body 103 of the mostly cylindrical ferrule 100.

In FIG. 1 the ferrule 100 is illustrated in the locked state, in which the external radial pressure has already been applied onto the ferrule 100 and the locking projection 111 has been pushed into the locking recess 113 via the insertion opening 115, being pressed against the deformation wall 117 and plastically deformed into the deformed state DS, in which the locking projection 111 extends at least partially into the undercut 119 of the locking recess 113.

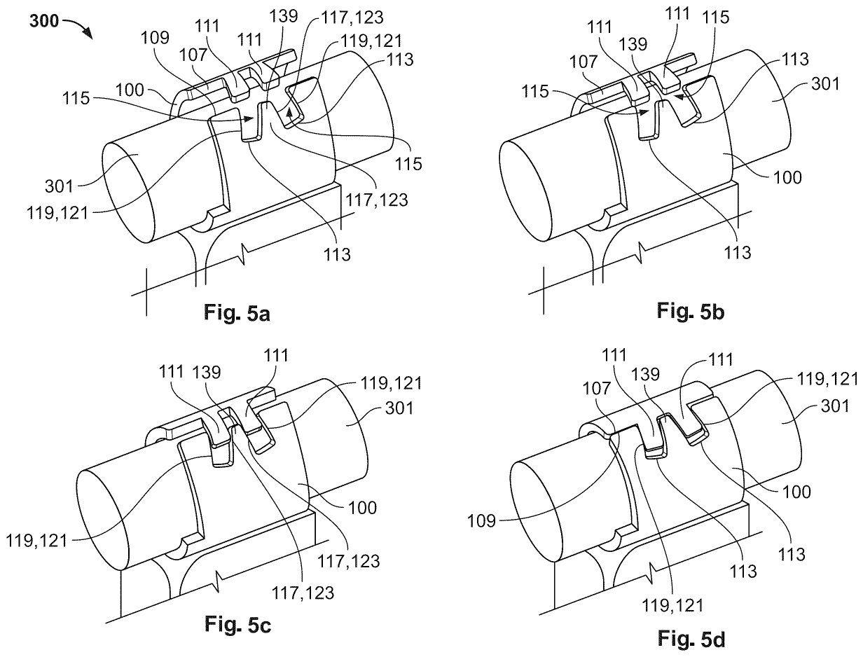

For a more detailed description of the process of generating the self-locking effect by applying the external radial pressure onto the ferrule 100, it is referred to the description related to FIG. 5.

In the shown embodiment, the undercut 119 of the projection recess 113 is formed by a first side wall 121 of the locking recess 113. In the shown embodiment the first side wall 121 is formed as a sloped side wall comprising an angle β with respect to the second flank 109, with β being smaller than 90° degrees. In the shown embodiment the undercut 119 has a sloped shape with respect to the second flank 109.

In the shown embodiment, the deformation wall 117 is formed by a second side wall 123. The second side wall 123 is also formed as a sloped side wall comprising a slope corresponding to the slope of the first side wall 121. The second side wall 121 is angled to the second flank 109 by an angle γ being respectively larger than 90° degrees.

In the shown embodiment, the locking projection 111 has a beam shape expanding in circumferential direction CD from the first flank 107.

In the shown deformed state DS the locking projection 111 comprises an angle α to the first flank 107 being larger than 90° degrees. As the locking projection 111 is inserted into the locking recess 113 by means of the external radial pressure and is plastically deformed into the deformed state DS the locking projection 111 comprises a deformed outline and/or enlarged or reduced base area.

By means of the plastic deformation, the locking projection 111 can be deformed such that the locking projection 111 in the deformed state DS comprises a deformed outline and/or base area mostly corresponding to an outline and/or base are of the locking recess 113.

As a result, the locking projection 111 is deformed such that the locking projection 111 in the deformed state DS fits tightly into the locking recess 113. In FIG. 1 a gap between the locking recess 113 and the locking projection 111 is visible. This only due to illustration purposes and shall not restrict the current invention.

In the shown embodiment, the locking projection 111 in the deformed state DS comprises an angle α between a longitudinal direction LD of the locking projection 111 and the first flank 107 of the ferrule body 103. Angle α is respectively larger than 90° degrees and in the shown embodiment corresponds to the angle γ between the second flank 109 and the second side wall 123 of the locking recess 113.

In the shown embodiment, the first side wall 121 and the second side wall 123 are both formed as straight side walls being tilted by the respective angles β, γ with respect to the second flank 109.

Respectively the locking projection 111 comprises a straight beam-like shape, which in the deformed state DS is angled to the first flank 107 by means of angle α.

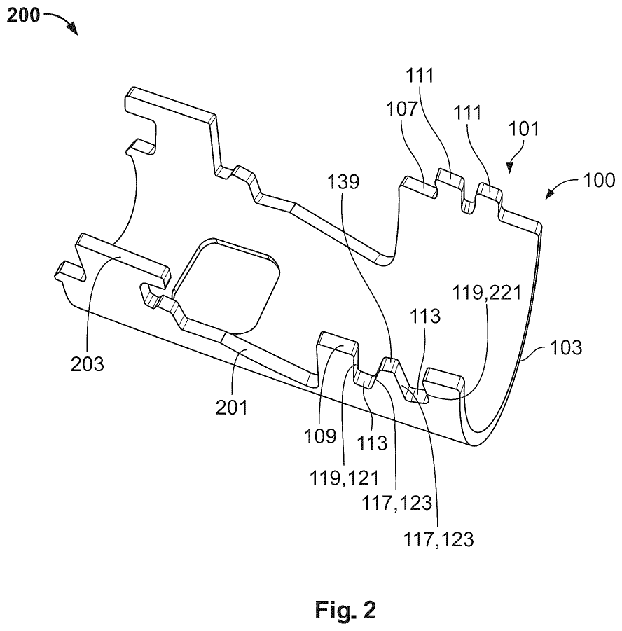

FIG. 2 shows a perspective schematic view of an electrical contact element 200 with an electrical ferrule 100 according to an embodiment.

In the shown embodiment, the electrical contact element 200 comprises a ferrule 100 connected to a contact element body 201 comprising a contacting structure 203 arranged on an opposite end of the contact element body 201 relative to the ferrule 100.

In FIG. 2 the ferrule 100 is illustrated in an open state, in which the first and second flanks 107, 109 are distanced to each other and the self-locking arrangement 101 is positioned in an open state with the locking projection 111 and the locking recess 113 being disengaged from each other.

The ferrule 100 illustrated in FIG. 2 is based on the embodiment shown in FIG. 1 and comprises all elements illustrated there.

Deviating from the embodiment shown in FIG. 1, the ferrule 100 shown in FIG. 2 comprises a self-locking arrangement 101 comprising two locking projections 111 expanding from the first flank 107 and to respective locking recesses 113 formed in the second flank 109.

The locking projections 111 are formed similar to the locking projection 111 shown in FIG. 1 as straight beam shaped projections. The locking recesses 113 are also formed similar to the locking recess 113 shown in FIG. 1 comprising an insertion opening 115, a deformation wall 117 and an undercut 119. The undercuts 119 are formed by sloped first side walls 121. The deformation walls 117 are formed as respectively sloped second side walls 123 of the respective locking recesses 113.

In the shown embodiment, the two locking recesses 113 are formed with opposite tilting angles β, γ with respect to the circumferential direction CD and therefore expand in opposite directions relative to the axial direction AD of the ferrule body 103.

As a result, between the two locking recesses 113 a wedge element 139 is formed at the second flank 109. The wedge element 139 comprises a pyramidical or triangular or wedge shape with the two sloped side faces of the pyramid being formed by the two sloped second side walls 123 of the two locking recesses 113.

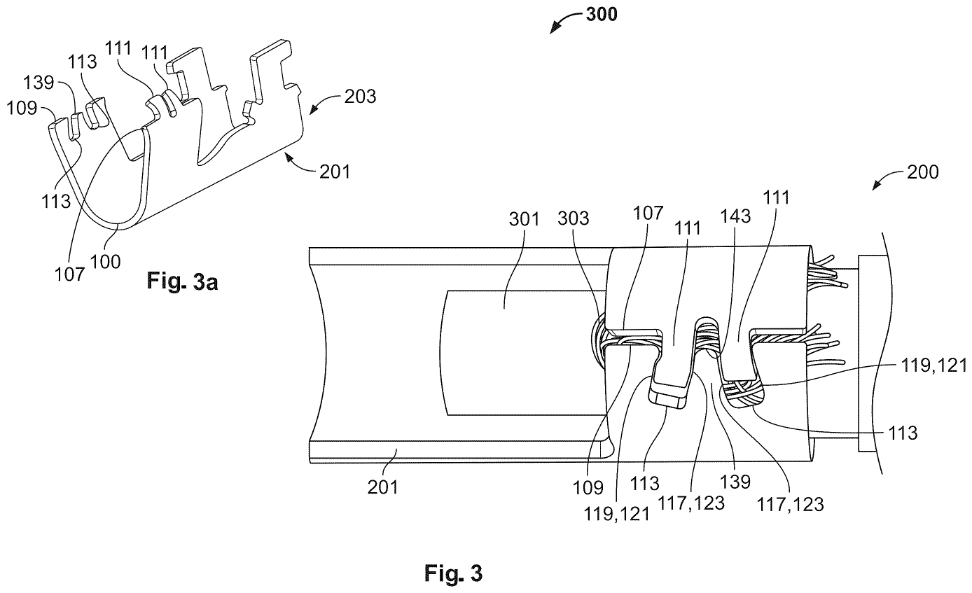

FIG. 3 shows a perspective schematic view of a system 300 comprising an electrical contact element 200 with an electrical ferrule 100 according to an embodiment.

FIG. 3 shows the electrical contacting element 200 of FIG. 2 in a closed state, in which the locking projections 111 and the locking recesses 113 of the self-locking arrangement 101 of the ferrule 100 are in an engaged state, in which the locking projections 111 are inserted into the respective locking recesses 113, deformed to the deformed states DS and extend into the undercut 119 of the locking recesses 113.

FIG. 3 illustrates the fact that the two locking recesses 113 are tilted away from each other and by this form the wedge element 139 between the two locking recesses 113. The wedge element 139 has a pyramidical shape with the two side faces of the pyramid being formed the two sloped second side walls 123 of the respective locking recesses 113.

A peak portion 143 of the pyramidical wedge element 139 is formed by the second flank 109. The side face 177 of the pyramid are formed by the sloped second side wall 123 of the two locking recesses 113.

As illustrated in FIG. 3, the two locking projections 111 are inserted into the locking recesses 113 and deformed into the deformed states DS in which the shapes of the locking projections 111 mostly corresponds to the shapes of the respective locking recesses 113.

In FIG. 3 the ferrule 100 is contacted to the illustrated conductor 301 of the system 300. The conductor 301 is formed as a cable. The connection between the ferrule 100 and the conductor 301 is achieved by the execution of a crimping process, in which the external radial pressure is applied onto the ferrule 100 leading to the engagement of the locking projections 111 and the locking recesses 113 of the self-locking arrangement 101.

In the shown embodiment between the conductor 301 and the ferrule 100 a braid 303 is arranged in order to increase the mechanical and electrical contacting between the ferrule 100 and the conductor 301.

FIG. 3a shows the respective electrical contacting element 200 in an open state, in which the locking projection 111 and locking recesses 113 of the self-locking arrangement 101 are disengaged from each other.

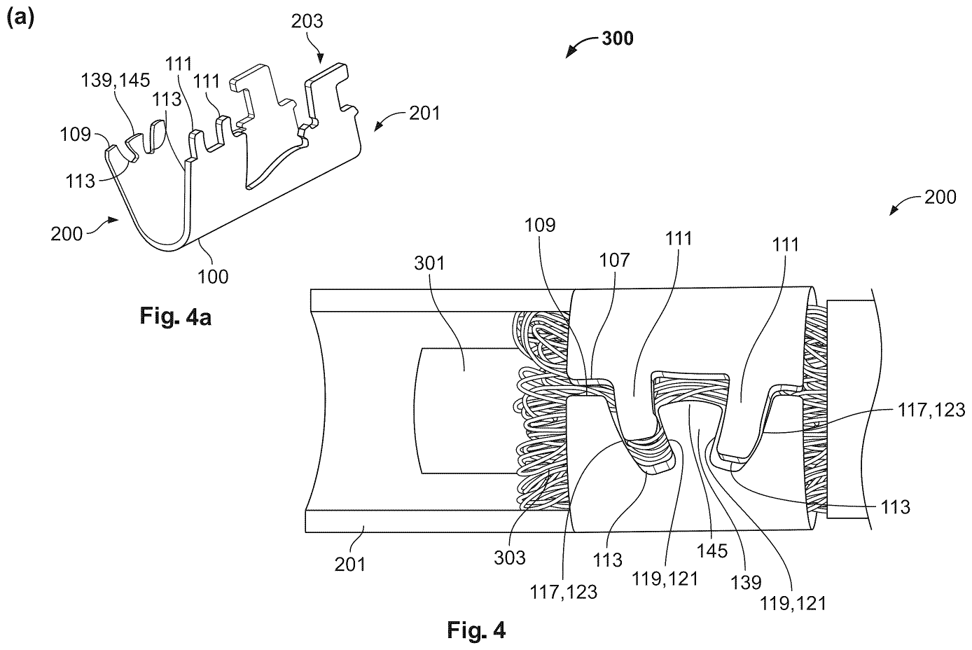

FIG. 4 shows another perspective schematic view of a system 300 comprising an electrical contact element 200 with an electrical ferrule 100 according to another embodiment.

FIG. 4 shows a different embodiment of the system 300 illustrated in FIG. 3. The electrical contacting element 200 and the ferrule 100 are based on the embodiment shown in FIG. 3 and comprise all features illustrated there.

Deviating from the embodiment in FIG. 3, in FIG. 4 the two locking recesses 113 are formed with slopes that are oriented in direction towards each other. Thus, the two locking recesses 113 extend in direction towards each other. As a result, the wedge element 139 formed between the two locking recesses 113 comprises an upside down pyramidical shape with a base face 145 of the pyramid being formed by the second flank 109.

FIG. 4a shows the respective electrical contacting element 200 in an open state, in which the locking projection 111 and locking recesses 113 of the self-locking arrangement 101 are disengaged from each other.

FIG. 5 shows an illustration of a method of assembling a system 300 comprising an electrical contact element 200 with an electrical ferrule 100 according to an embodiment.

FIGS. 5a, 5b, 5c and 5d show different states of the engagement process of the self-locking arrangement 101 achieved by the external radial pressure applied onto the ferrule 100.

The illustrated ferrule 100 is based on the embodiment shown in FIG. 3. In the shown embodiment, the locking arrangement 101 comprises two locking projections 111 formed on the first flank 107 of the ferrule body 103 and two respected locking recesses 113 formed in the second flank 109. The design of the self-locking arrangement 101 is identical to the design shown in the embodiment in FIG. 3, and therefore will not be described in further detail.

In FIG. 5a, the ferrule 100 is illustrated in an open state, in which the locking projections 11 and locking recesses 113 of self-locking arrangement 101 are not engaged and the first and second flanks 107, 109 and distanced to each other.

By application of the external radial pressure onto the ferrule 100 positioned around the illustrated conductor 301 the ferrule body 103 is bent around the circumference of the illustrated conductor 301 and the first and second flanks 107, 109 are moved closer to each other.

In FIG. 5b, due to the external pressure and the respective bending of the ferrule body 103, the two locking projections 111, which are still in an undeformed state are pushed into the respective locking recesses 113 and enter the locking recesses 113 via the respective insertion openings 115.

As the crimping process continues and the ferrule body 103 is more and more bent around the circumference of the illustrated conductor 301, the locking projections 111 are pushed further into the respective locking recesses 113 and finally are pressed against the deformation walls 117 of the respective locking recesses 113.

Due to the slope of the sloped second side walls 123 forming the respective deformation walls 117, the previously undeformed locking projections 111 are now plastically deformed into the previously illustrated deformed state DS.

As the locking projections 111 are further introduced into the respective locking recesses 113 by means of the external radial pressure the locking projections 111 slide along the sloped second side walls 123 forming the deformation walls 117 and are plastically deformed even further.

As illustrated in FIG. 5d, due to the continuous application of the external radial pressure of the crimping process and the further bending of the ferrule body 103 the locking projections 11 are further inserted into the locking recesses 113 and are further deformed by means of the sloped deformation walls 117 and consequentially extend further into the undercut 119 of the locking recesses 113.

Depending on the amount of applied external radial pressure, the locking illustrated in FIG. 5d, can be achieved with different states of bending the ferrule body 103.

The ferrule body 103 can be bent completely until the first and second flanks 107, 109 contact each other. Alternatively, the ferrule body 103 can be bent to the point where the gap 105 between the first and second flanks 107, 109 is still opened.

The self-locking arrangement 101 provides a locking of the ferrule 100 in its bended state regardless whether the ferrule body 103 is bent to its maximum and the first and second flanks 107, 109 contact each other or a gap between the first and second flanks 107, 109 is still open.

As long as the respective locking projections 111 are deformed into the deformed state DS and extend into the respective undercuts 119 of the locking recesses 113, a locking of the ferrule body 103 in its bent state is achieved.

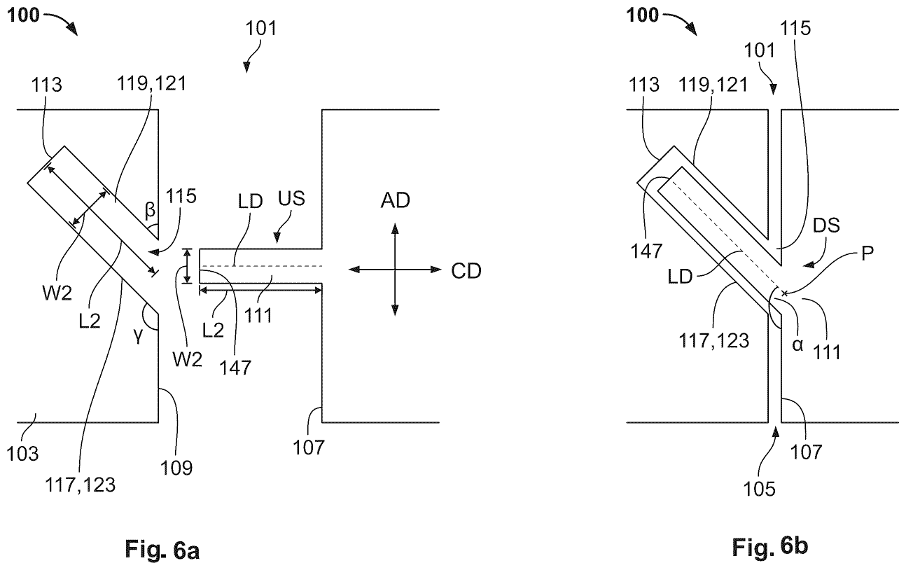

FIG. 6 shows a schematic view of an electrical ferrule 100 according to an embodiment.

FIGS. 6 to 11 show different embodiments of the self-locking arrangement 101 and illustrate the locking mechanism provided by the arrangement 101.

For simplification of said figures, FIGS. 6 to 11 only show parts of the ferrule 101 and in particular are limited to the first and second flanks 107, 109 and the respective features of the self-locking arrangement 101.

FIGS. 6a, 7a, 8a, 9a, 10a and 11a always show the self-locking arrangement 101 in an unengaged state. FIGS. 6b, 7b, 8b, 9b, 10b, 11b, show the self-locking arrangement 101 in an engaged state, in which the respective locking projections 111 are introduced into the locking recesses 113.

In the shown embodiment, the self-locking arrangement 101 comprises one locking projection 111 formed at the first flank 107 and one locking recess 113 formed in the second flank 109. In the shown embodiment the locking projection 111 has a beam-like shape and in the undeformed state US is oriented perpendicular to the first flank 107 and extends along the circumferential direction CD of the ferrule body 103.

The locking recess 113 comprises the insertion opening 115, the deformation wall 117 and the undercut 119. In the shown embodiment the undercut 119 is formed by a sloped first side wall 121 and the deformation wall 117 is formed by a sloped second side wall 123 of the locking recess 113.

The first and second sloped side walls 121, 123 are formed as straight walls and are angled with respect to the second flank 109. The first sloped side wall 121 comprises an angle β to the second flank 109 and the second sloped side wall 123 has an angle γ to the second flank 109. The angle β is smaller than 90° degrees due to the tilting of the locking recess 113 with respect to the second flank 109.

In the shown embodiment, the slope of the second side wall 123 is similar or identical to the first side wall 121. As a result, the angle γ is larger than 90° degrees and a sum of the angles β and γ results in 180° degrees.

In the shown embodiment, the locking projection 111 is positioned directly opposite to the insertion opening 115. In the shown embodiment the locking projection 111 comprises a beam-like shape with a rectangular free end 147.

The beam-like shaped locking projection 111 comprises a length L1 and a width W1. The locking recess 113 comprises a length L2 and a width W2.

The width W1 of the locking projection 111 can be slightly smaller than the width W2 of the locking recess 113. The length L1 of the locking projection 111 can be equal or smaller/larger than the length L2 of the locking recess 113.

The length L1, L2 can be in the millimeter range of close to 3 mm. The width W1, W2 can be in the millimeter of about 1 mm.

The angle β can be between 85° degrees and 45° degrees. The angle γ can be between 95° degrees and 135° degrees.

In the engaged state of the locking arrangement 101, the locking projection 111 is inserted into the locking recess 113 and plastically deformed to extend into the undercut 119.

In the shown embodiment, the beam-like shaped locking projection 111 is bent around a pivot point P right at the connection between the locking projection 111 and the second flank 107. In the deformed state DS, the locking projection 111 therefore comprises an angle α between a longitudinal direction LD of the locking projection 111 and the first flank 107.

According to an embodiment, the angle α can be equal to the angle γ of the deformation wall 117.

According to a further embodiment, the free end 147 can also be form with a rounded shape.

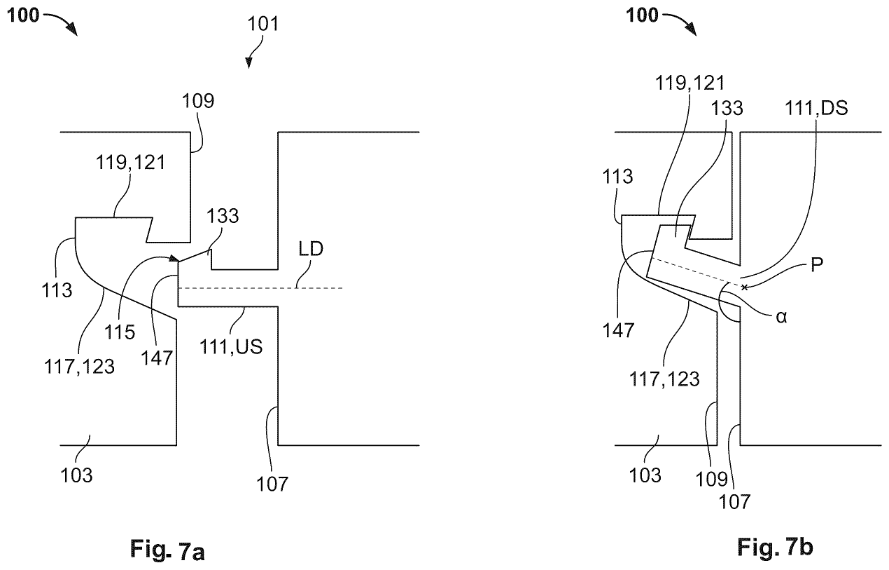

FIG. 7 shows another schematic view of an electrical ferrule 100 according to another embodiment.

In the shown embodiment, the self-locking arrangement 101 again comprises one locking projection 111 and one locking recess 113. In the shown embodiment, the locking projection 111 is formed in a beam-like shape and comprises a hook element 133 formed at the free end 147.

The undercut 119 of the locking recess 113 is formed by the first side wall 121 of the locking recess 113. In the shown embodiment, the first side wall 121 is formed as a straight wall, perpendicular to the second flank 109 and comprises the undercut 119. The deformation wall 117 is again formed as the sloped second side wall 123.

In the deformed state DS the locking projection 111 again is bent around the pivot point P according to the slope of the sloped second side wall 123 forming the deformation wall 117. Due to the bending of the locking projection 111 around the pivot point P direction of the undercut 119, the hook element 113 extends into the undercut 119 and provides the locking of the ferrule body 103 in the engaged state.

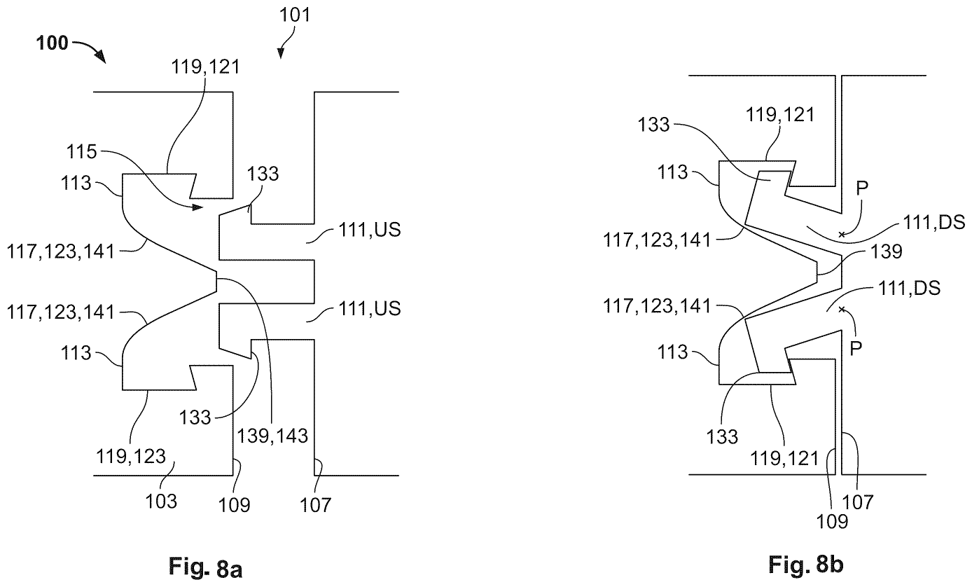

FIG. 8 shows another schematic view of an electrical ferrule 100 according to another embodiment.

The embodiment in FIG. 8 is based on the embodiment in FIG. 7. In the shown embodiment, the self-locking arrangement 101 comprises two locking projection 111 and two locking recesses 113. The locking projections 111 and the locking recesses 113 are designed identical to the embodiment in FIG. 7.

In the shown embodiment, the locking recesses 113 are positioned adjacent to each other such that the wedge element 139 is formed between the two locking recesses 113.

The wedge element 139 comprises a pyramidical shape with sloped side faces 141 of the pyramid being formed by the sloped second side wall 123 of the two locking recesses 113 and the peak portion 143 of the wedge element 139 being formed as part of the second flank 109.

By pushing the locking projections 111 into the locking recesses 113, the locking projections 111 are bent around the respective pivot points P in direction towards the undercuts 119 of the respective locking recesses 113 and the respective hook elements 133 extend into the locking recesses 113.

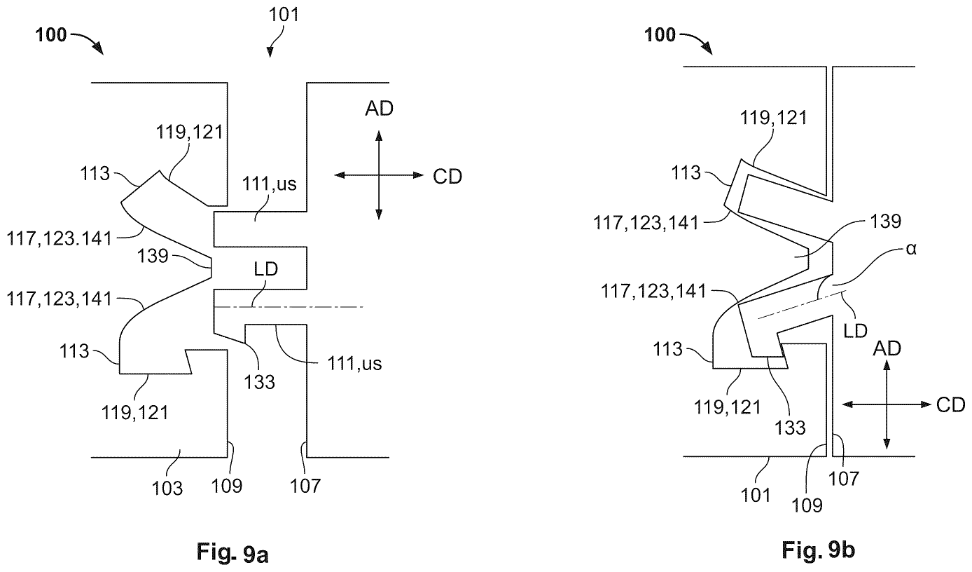

FIG. 9 shows another schematic view of an electrical ferrule 100 according to another embodiment.

The shown embodiment is a combination of the embodiments illustrated in FIGS. 6 to 8. The self-locking arrangement 101 comprises two locking projections 111 and two locking recesses 113.

In the shown embodiment one pair of locking projection 111 and locking recess 113 is designed corresponding to the embodiment shown in FIG. 6 with the locking projection 111 being beam shaped and the locking recess 113 having to parallel sloped side walls 121, 123.

The other pair of locking projection 111 and locking recess 113 is designed corresponding to the embodiment shown in FIG. 7 or FIG. 8 with the locking projection 111 comprising the hook element 133 and the undercut 119 of the locking recess 113 being formed in the straight first side wall 121 perpendicular to the second flank 109.

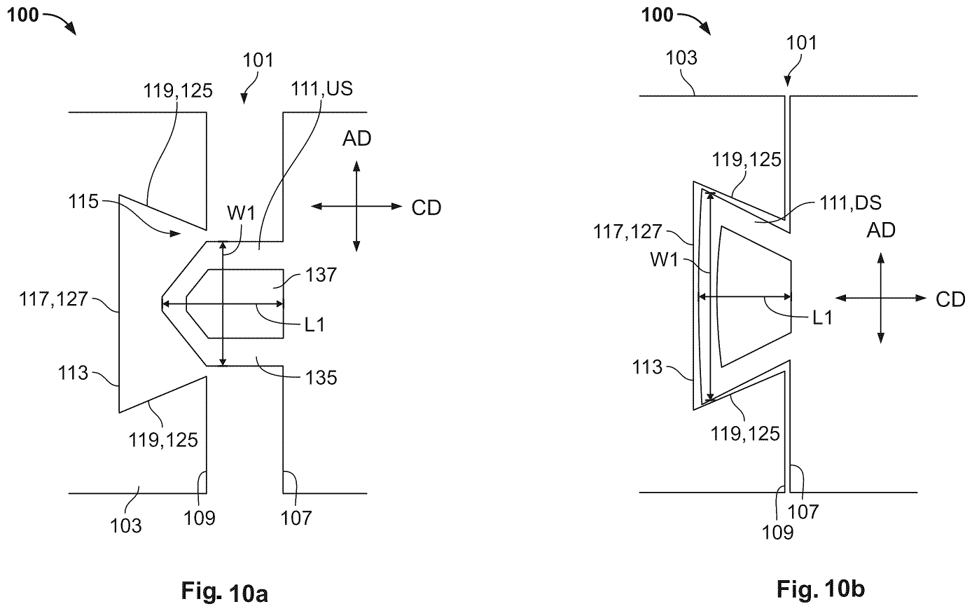

FIG. 10 shows another schematic view of an electrical ferrule 100 according to another embodiment.

In the shown embodiment, the self-locking arrangement 101 comprises one locking projection 111 formed on the first flank 107 and one locking recess 113 formed on the second flank 109.

In the shown embodiment, the locking projection 111 comprises a frame element 135 with a hollow inner region 137.

In the shown embodiment, the locking recess 113 comprises two undercuts 119 formed in two opposite side walls 125. The undercuts 119 are formed as two sloped side walls 124. The deformation wall 113 is formed as base wall 127 positioned opposite to the insertion opening 115 and mostly parallel to the second flank 109.

In the engaged state due to the locking projection 111 being pressed against the deformation wall 117 due to the applied external radial pressure, the locking projection 111 is deformed with respect to the circumferential direction CD as well as the axial direction AD of the ferrule body 103. This leads to the deformed locking projection 111 to shorten in distance along the circumferential direction CD and enlarge in width along the axial direction AD.

As a result, the shortened and widened plastically deformed locking projection 111 extends into the two undercuts 119 provided by the two opposite side walls 125 of the locking recess 113.

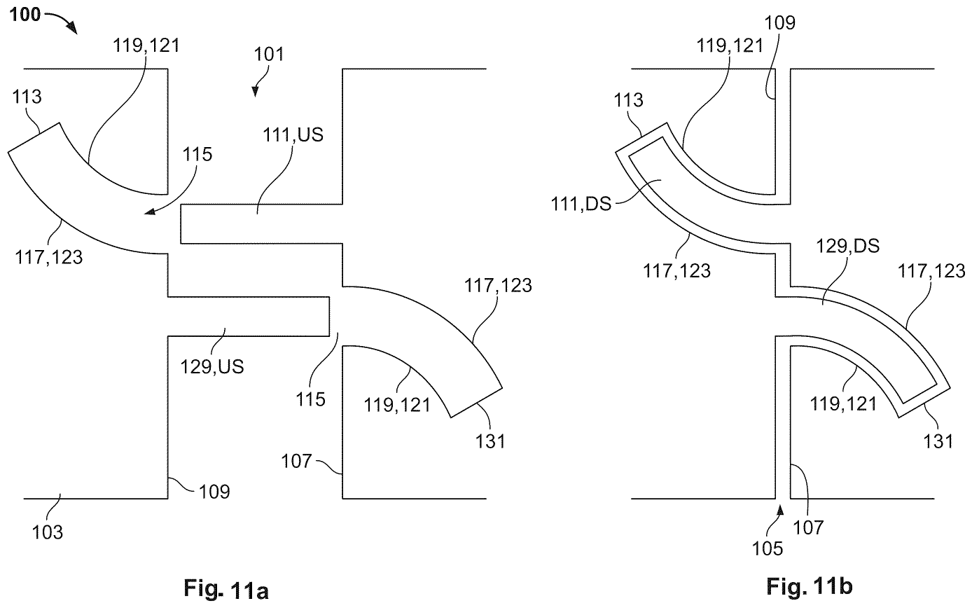

FIG. 11 shows another schematic view of an electrical ferrule 100 according to another embodiment.

In the shown embodiment, the self-locking arrangement 101 comprises a locking projection 111 and a respective locking recess 113. The locking projection 111 is formed at the first flank 107 and the locking recess 113 is formed in the second flank 109. In the shown embodiment, the locking arrangement 101 further comprises a further locking projection 129 formed at the second flank 109 and a further locking recess 131 formed in the first flank 107.

The two locking projection 111, 129 are formed identically with a beam shape and the locking recesses 113, 131 are formed with two sloped side walls 121, 123. In the shown embodiment, the two sloped side walls 121, 123 of the two locking recesses 113, 131 have a curved outline. The two side walls 121, 123 are formed mostly coaxial with comparable curvatures.

The engaging process and the locking process of the self-locking arrangement 101 functions identical to the previously discussed embodiments, in which due to the external radial pressure, the respective locking projections 111, 129 are pushed into the respective locking recesses 113, 131, are pressed against the deformation walls 117 and are deformed into a plastically deformed state DS, in which the deformed locking projections 111, 129 extend at least partially into the undercuts 119 of the respective locking recesses 113, 131.

Due to the curved side walls 121, 123 of the locking recesses 113, 131, the beam-like shaped locking projections 111, 129 are not only bent around the pivot point P but are completely deformed into a curved beam-like shape.

With respect to FIGS. 1 to 11, several different embodiments of the current invention have been discussed. However, the current invention shall not be limited to the discussed embodiments. Further embodiments are possible. For example, a combination of the different shown embodiments also falls under the scope of protection.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. An electrical ferrule comprising:
a ferrule body comprising a first flank and a second flank extending along an axial direction of the ferrule body; and
a self-locking arrangement including at least one locking projection formed on the first flank and at least one locking recess formed on the second flank, wherein the locking recess comprises an insertion opening, a deformation wall and at least one undercut, wherein the locking projection is arranged to be pushed into the locking recess via the insertion opening, to be pressed against the deformation wall and to be plastically deformed into a deformed state when an external radial pressure is applied onto the ferrule, and wherein the locking projection in the deformed state is arranged to at least partially extend into the at least one undercut of the locking recess.

2. The ferrule according to claim 1, wherein the locking projection is arranged to be plastically deformed in a circumferential direction and/or the axial direction of the ferrule body.

3. The ferrule according to claim 1, wherein in an undeformed state the locking projection does not extend at least partially into the at least one undercut of the locking recess.

4. The ferrule according to claim 1, wherein in the deformed state the locking projection comprises a deformed shape with a deformed outline and/or an enlarged or reduced base area.

5. The ferrule according to claim 1, wherein the undercut is formed by a first side wall of the locking recess, wherein the deformation wall is formed by a second side wall of the locking recess, and wherein the second side wall is formed as a sloped wall with a slope of the second side wall being oriented in direction of the first side wall.

6. The ferrule according to claim 5, wherein the first side wall is formed as a sloped wall with a slope of the first side wall aligned to the slope of the second side wall.

7. The ferrule according to claim 5, wherein the first side wall is formed as a straight wall comprising the undercut.

8. The ferrule according to claim 1, wherein the locking recess comprises two undercuts formed on two sidewalls of the locking recess, and wherein the deformation wall is formed by a base wall opposite to the insertion opening.

9. The ferrule according to claim 1, wherein the self-locking arrangement further comprises at least one further locking projection formed on the second flank and at least one further locking recess formed on the first flank, wherein the further locking recess comprises an insertion opening, a deformation wall and at least one undercut, wherein the further locking projection is arranged to be pushed into the locking recess via the insertion opening, to be pressed against the deformation wall and to be plastically deformed into a deformed state when an external radial pressure is applied onto the ferrule, and wherein the further locking projection in the deformed state is arranged to at least partially extend into the at least one undercut of the further locking recess.

10. The ferrule according to claim 1, wherein the locking projection comprises a beam shape, and/or wherein the locking projection comprises at least one hook element arranged to extend into the at least one undercut.

11. The ferrule according to claim 1, wherein the locking projection is formed as a frame element with a hollow inner region.

12. The ferrule according to claim 1, wherein the ferrule body is formed in one piece by means of a punching process and a bending process.

13. A system comprising:
an electrical contact element including a ferrule, the ferrule including a ferrule body having a first flank and a second flank extending along an axial direction of the ferrule body, the ferule including a self-locking arrangement including at least one locking projection formed on the first flank and at least one locking recess formed on the second flank, wherein the locking recess comprises an insertion opening, a deformation wall and at least one undercut, wherein the locking projection is arranged to be pushed into the locking recess via the insertion opening, to be pressed against the deformation wall and to be plastically deformed into a deformed state when an external radial pressure is applied onto the ferrule, and wherein the locking projection in the deformed state is arranged to at least partially extend into the at least one undercut of the locking recess; and
a conductor,
wherein the ferrule is positioned on the conductor, wherein the ferrule is connected to the conductor by means of a crimp connection, wherein the locking projection of the first flank of the ferrule body protrudes into the locking recess of the first flank of the ferrule body, contacts the deformation wall, is plastically deformed to the deformed state and extends at least partially into the at least one undercut of the locking recess, and wherein the plastic deformation of the locking projection at least partially into the undercut results in an external radial pressure applied onto the ferrule during a crimping process to achieve the crimp connection.

14. The system according to claim 13, wherein the locking projection is arranged to be plastically deformed in a circumferential direction and/or the axial direction of the ferrule body.

15. The system according to claim 13, wherein in an undeformed state the locking projection does not extend at least partially into the at least one undercut of the locking recess.

16. The system according to claim 13, wherein in the deformed state the locking projection comprises a deformed shape with a deformed outline and/or an enlarged or reduced base area.

17. The system according to claim 13, wherein the undercut is formed by a first side wall of the locking recess, wherein the deformation wall is formed by a second side wall of the locking recess, and wherein the second side wall is formed as a sloped wall with a slope of the second side wall being oriented in direction of the first side wall.

18. The system according to claim 13, wherein the locking recess comprises two undercuts formed on two sidewalls of the locking recess, and wherein the deformation wall is formed by a base wall opposite to the insertion opening.

19. The system according to claim 13, wherein the self-locking arrangement further comprises at least one further locking projection formed on the second flank and at least one further locking recess formed on the first flank, wherein the further locking recess comprises an insertion opening, a deformation wall and at least one undercut, wherein the further locking projection is arranged to be pushed into the locking recess via the insertion opening, to be pressed against the deformation wall and to be plastically deformed into a deformed state when an external radial pressure is applied onto the ferrule, and wherein the further locking projection in the deformed state is arranged to at least partially extend into the at least one undercut of the further locking recess.

20. A method for assembling a system, comprising:
providing an electrical contact element including a ferrule positioned on a conductor, the ferrule including a ferrule body having a first flank and a second flank extending along an axial direction of the ferrule body, the ferule including a self-locking arrangement including at least one locking projection formed on the first flank and at least one locking recess formed on the second flank, wherein the locking recess comprises an insertion opening, a deformation wall and at least one undercut, wherein the locking projection is arranged to be pushed into the locking recess via the insertion opening, to be pressed against the deformation wall and to be plastically deformed into a deformed state when an external radial pressure is applied onto the ferrule, and wherein the locking projection in the deformed state is arranged to at least partially extend into the at least one undercut of the locking recess; and
executing a crimping process by applying external radial pressure onto the ferrule positioned on the conductor and by this pushing the locking projection into the locking recess via the insertion opening, pressing the locking projection against the deformation wall and plastically deforming the locking projection into a deformed state pf the locking projection at least partially extending into the undercut of the locking recess.
